(19) United States
(12) Patent Application Publication
(10) Pub. No.: US 2012/0060865 A1
(43) Pub. Date: Mar. 15, 2012

(54) METHOD AND DEVICE FOR RESTORING OF CORES

(75) Inventors: Jörgen Jensen, Falkenberg (SE); Jan Karlsson, Falkenberg (SE); Nils Strandh, Gullbrandstorp (SE)

(73) Assignee: Core Link AB, Falkenberg (SE)

(21) Appl. No.: 13/244,451

(22) Filed: Sep. 24, 2011

(30) Foreign Application Priority Data
Sep. 10, 2010 (SE) 1000999-1

(51) Int. Cl. B08B 1/00

(52) U.S. Cl. 134/6; 15/236.01

(57) ABSTRACT

A method (and device) of removing material residues, from cores to make possible reuse of them in the same manner as new and unused cores a number of times wherein cores with material residues in the form of a number of material turns are processed using a mechanism for lifting and tearing the material residues for subsequent simple removal thereof, the mechanism for lifting and tearing of the material residues is displaced along the core and the mechanism for lifting and tearing of the material residues is displaced from a position in on the core out towards and past the ends of the core.

The present invention relates to a method according to the preamble to appended claim 1 and a device for carrying the same into effect.

In particular within the tissue industry, use is made of large cores of an inner diameter of, for example, 250 to 600 mm. For economic and not least environmental reasons, it is a major advantage if such cores can be recycled and reused as many times as possible. Hitherto, such cores have been cleaned from material residues manually using knives. This often leads to damage to the extremely sensitive casing material and such damage makes reuse of these cores impossible. There is thus a major need in the art for a method and a device for restoring used cores in as gentle a manner as possible without damage to the sensitive casing material of the core.

The task forming the basis of the present invention is to realise such a method and a device for carrying the method into effect.

This task is realised by means of the present invention in the method disclosed by way of introduction in that the method has been given the characterising features as set forth in appended claim 1 and the device for carrying the method into effect has been given the characterising features as set forth in appended claim 4.

The present invention realises an as good as automatic cleaning or restoring of used cores for use within the tissue industry to the same condition as new and unused cores as good as without risk of damage to the sensitive casing material. This implies major savings from both the economic and the environmental viewpoints.

The present invention will now be described in greater detail hereinbelow with reference to the accompanying Drawings.

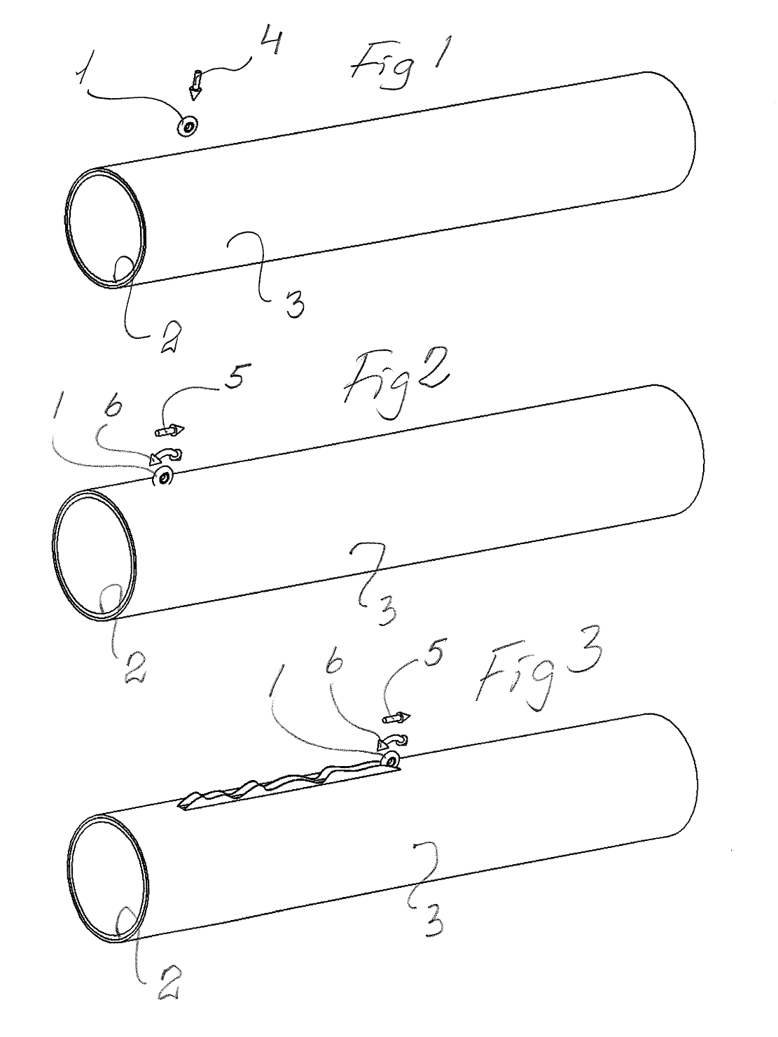

FIG. 1 is a perspective view of a core at a part of a device according to one embodiment of the present invention.

FIG. 2 is a view similar to that of FIG. 1 but with the part in a different position.

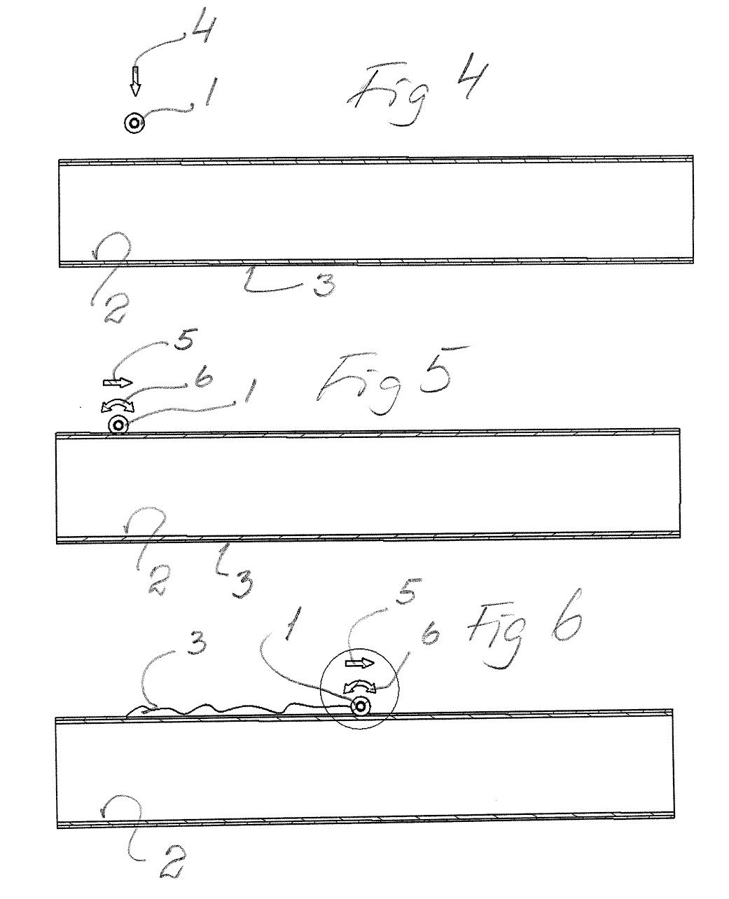

FIG. 3 is a view similar to those of FIGS. 1 and 2 with the part in yet another position.

FIG. 4 is a longitudinal section through the parts in FIG. 1.

FIG. 5 is a longitudinal section through the parts in FIG. 2.

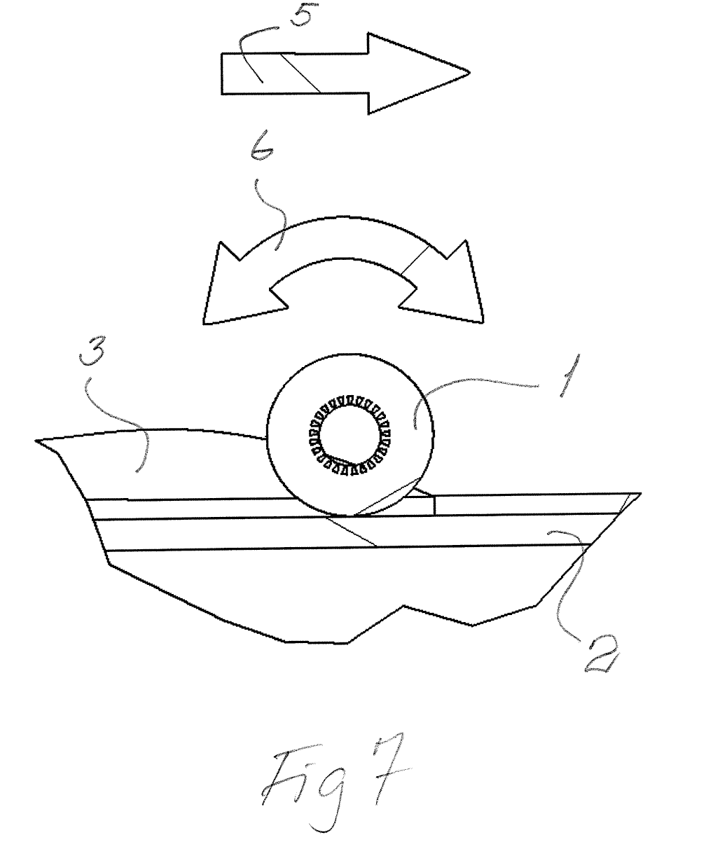

FIG. 6 is a longitudinal section through the parts in FIG. 3.

FIG. 7 shows, on a larger scale, a part of the longitudinal section in FIG. 6, the part being encircled.

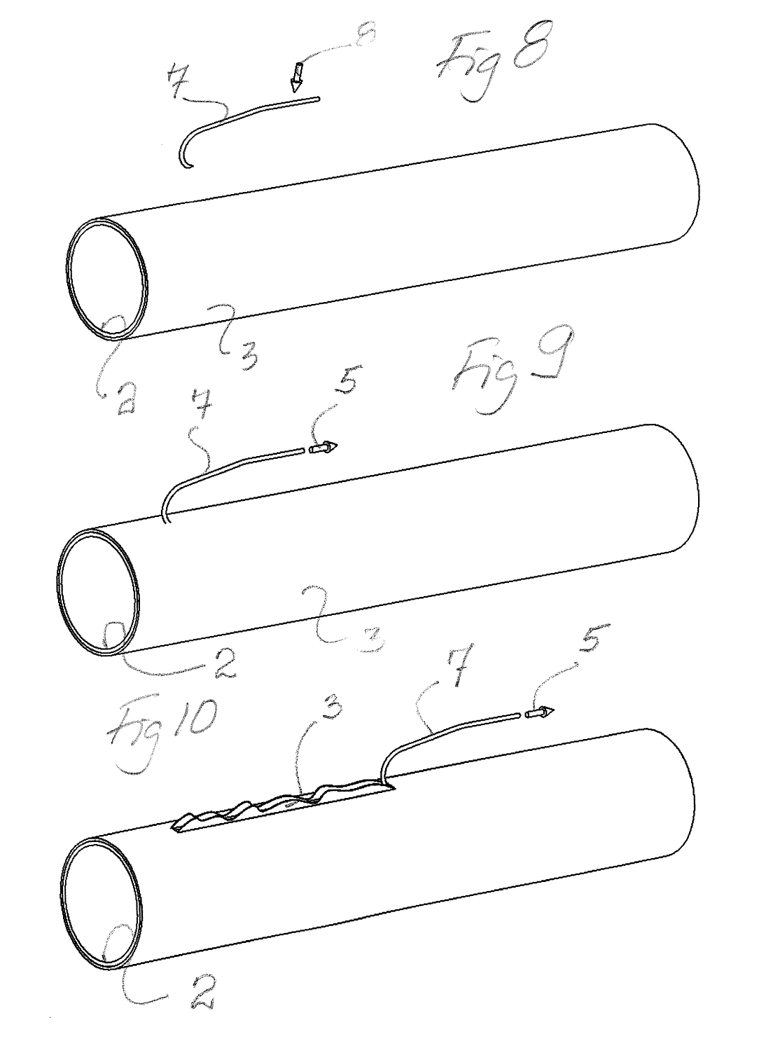

FIG. 8 is a perspective view of a core at a part of a device according to another embodiment of the present invention.

FIG. 9 is a view similar to that of FIG. 8 with the part in a different position.

FIG. 10 is a view similar to those of FIGS. 8 and 9 with the part in yet another position.

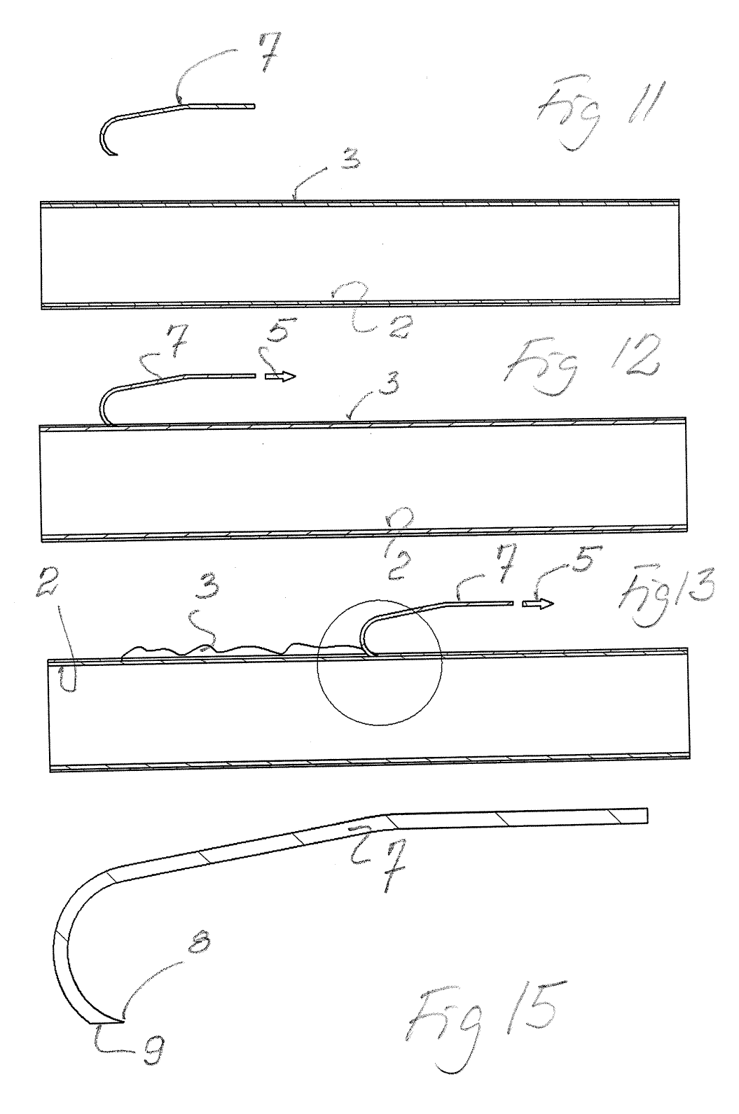

FIG. 11 is a longitudinal section through the parts in FIG. 8.

FIG. 12 is a longitudinal section through the parts in FIG. 9.

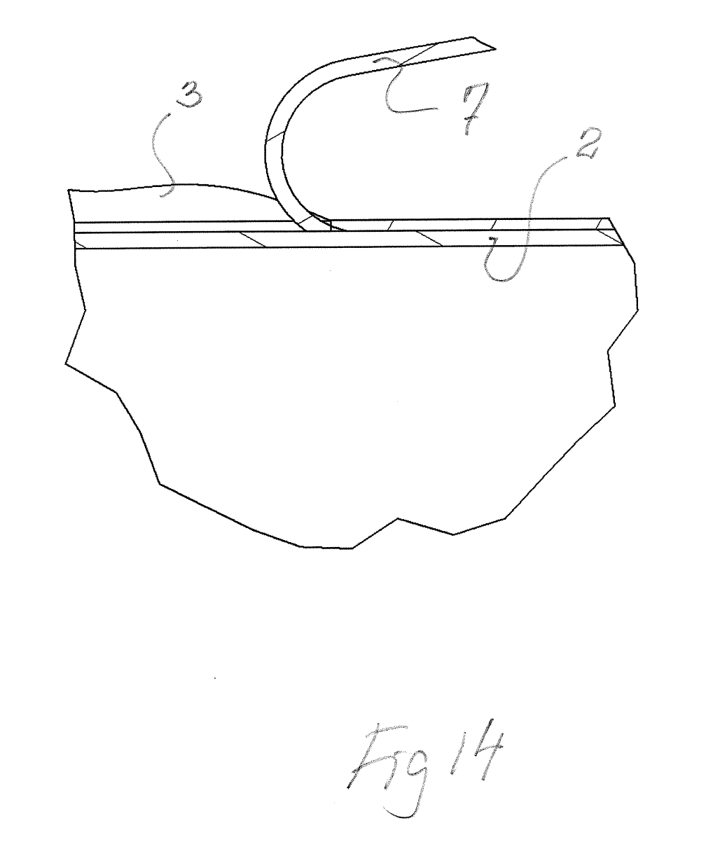

FIG. 13 is a longitudinal section through the parts in FIG. 10.

FIG. 14 shows, on a larger scale, a part of the longitudinal section in FIG. 13, the part being encircled.

FIG. 15 is a view of a part of a device according to one embodiment of the present invention.

The method according to the present invention will be clearly apparent in the following description of different embodiments of a device according to the present invention for carrying the method into effect.

A core with material residues in the form of a relatively large number of turns of paper tissue is processed in a core cleaner or roll cutter with a circular knife of per se known type for removing the greater part of the tissue. The innermost layers or turns of the tissue are left on the core so that the sensitive casing surface of the core is not subjected to any damage by the parts in the core cleaner or roller cutter. Those parts which may entail damage to the casing surface of the core are moved aside or the core is moved away from them in order to make possible continued processing of the material residues on the core according to the present invention.

In FIGS. 1-7 there is illustrated a device according to one embodiment of the present invention, consisting of a wheel 1 which is urged against a core 2 with tissue 3 in the direction of the arrow 4. The wheel 1 has a friction surface and is advantageously manufactured from rubber or a rubber-like material, e.g. polyurethane. The wheel 1 may have a rounded narrow circumferential surface. The wheel 1 is displaced in the direction of the arrow 5 in FIG. 2 along the core 2 and is rotated in accordance with the arrow 6 in a direction towards the direction of displacement in accordance with the arrow 5 to the end of the core 2. Before the wheel 1 is displaced in the opposite direction to the opposite end of the core 2, its direction of rotation is reversed so that the wheel 1 rotates towards the axial direction of movement. This alternating displacement of the wheel 1 is continued until the tissue is split up as intimated in FIGS. 3, 6 and 7 and until the casing surface of the core 2 is visible. It is important that the wheel 1 is mounted resiliently so that the casing surface of the core 2 is not damaged.

It is also possible to rotate the wheel 1 with the axial direction of displacement on condition that its peripheral speed is different from (preferably greater than) the axial speed of displacement. One advantage with this is that it is possible to avoid the occurrence of a so-called “rolled edge” of the tissue, which is extremely difficult to split but must be cut, with considerable risk of damage to the casing surface of the core 2.

After the lifting and splitting or tearing of the tissue according to the preceding paragraph, either the core 2 may be rotated, a doctor blade be applied in the opening and the core rotated, or air be blown down into the opening thus created for removal of the tissue. These removal methods may naturally also be combined with one another for removal of residual tissue from the core 2.

FIGS. 8-15 illustrate another embodiment of a device according to the present invention in which the wheel 1 has been replaced by a hook 7 which, in a position slightly inside the end of the core 2, is urged in the direction of the arrow 8 towards the material residues or the tissue 3 on the core 2 and is displaced axially along the core 2 in the direction of the arrow 5 to the opposite end of the core 2. In this displacement, the hook 7 or its tip 8 will strive down towards the casing surface of the core 2 and parallel therewith while tearing up the tissue 3, until the end of the core 2 has been passed. Either the hook 7 may be reversed or another similar hook may be provided for displacement in the opposite direction after engagement in the tissue a distance inside the opposite end of the core 2. The hook 7 or the hooks are displaced reciprocally on the core 2 until the surface 9 of the tip 8 comes into abutment against the casing surface on the core 2 and is displaced thereon without causing any damage. To this end, the surface 9 may be directed slightly upwards towards the tip 8 proper. Changes in the direction of the surface 9 towards and away from a parallel state with the casing surface of the core may be realised by pivoting the hook 7 and its tip 8 upwards or downwards.

After the raising and splitting or tearing of the tissue according to the preceding paragraph, either the core 2 may be rotated, a doctor blade applied in the opening and the core rotated or air blown down into the opening created for removal of the tissue. These removal methods may naturally also be combined with one another for removal of the residual tissue from the core 2.

In combination with a core cleaner or a roll cutter with circular fixed or rotating knife, a wheel 1 or a hook 7 may be disposed on one or both sides of the knife in the core cleaner or roll cutter and be lifted or lowered with the knife and may also be moveable independently of the knife. Suitably, the hook 7 may be pivotally mounted about its opposite end in relation to the tip 8 and may be connected to a cylinder or the like for pivoting against the casing surface of the core 2 with the desired force. Trials have demonstrated that it is sufficient to use the natural weight of the hook 7 in order for the hook to penetrate into and down in the tissue 3.

Many modifications of the above described embodiments according to the present invention are naturally conceivable without departing from the scope of the inventive concept as defined in the appended Claims.

1. A method of removing material residues, from cores in order to make possible reuse thereof in a same manner as new and unused cores a number of times,
wherein cores with material residues in a form of a number of material turns are processed using means for lifting and tearing of a material residues for subsequent simple removal thereof, said means for lifting and tearing of the material residues are displaced along the core and said means for lifting and tearing of the material residues are displaced from a position in on the core out towards and past the ends of the core.

2. The method as claimed in claim 1, wherein said means for lifting and tearing of the material residues are urged thereagainst for penetration down into them towards the casing surface of the core under lifting and tearing of the material residues on the core during displacement out towards the end of the core and possibly past the end of the core.

3. The method as claimed in claim 1, wherein a plurality of means for lifting and tearing of the material residues on the core are displaced each from its position on the core out towards and past each end of the core.

4. A device for carrying the method according to claim 1 into effect, wherein said means for lifting and tearing of the material residues comprises a wheel or a hook which is displaced from a position inside the ends of the core to the opposite end during lifting and tearing of the material on the core during urging against the material on the core.

5. The device as claimed in claim 4, wherein the wheel is provided with a friction surface and is connected to means for rotation thereof against their axial direction of displacement over the core.

6. The device as claimed in claim 4, wherein the wheel is connected to means for rotation thereof with its axial direction of displacement at a peripheral speed which is different from, the speed of the axial displacement.

7. The device as claimed in claim 4, wherein the wheel is yieldably applied against the core and the material residues thereon.

8. The device as claimed in claim 4, wherein the hook is provided with a tip in its direction of displacement, the tip being located on the end of tip carrier, and that the end has an abutment surface turned to face towards the core, the abutment surface being slightly inclined in an upward direction from the core in the direction of displacement of the hook so that the tip is located slightly above the casing surface of the core on abutment of the hook thereagainst.

9. The device as claimed in claim 8, wherein from the tip of the hook, the surface facing away from the core slopes upwards away from the core for lifting of the penetrated material up from the core.

10. The device as claimed in claims 8, wherein the tip of the hook has a rounded extent in the horizontal plane and is speculated in the vertical plane.

11. The method as claimed in claim 2, wherein a plurality of means for lifting and tearing of the material residues on the core are displaced each from its position on the core out towards and past each end of the core.

12. The device as claimed in claim 5, wherein the wheel is connected to means for rotation thereof with its axial direction of displacement at a peripheral speed which is different from, preferably higher than, the speed of the axial displacement.

13. The device as claimed in claim 9, wherein the tip of the hook has a rounded extent in the horizontal plane and is speculated in the vertical plane.
